(19) United States
(12) Patent Application Publication
(10) Pub. No.: US 2005/0146404 A1
(43) Pub. Date: Jul. 7, 2005

(54) Microengineered self-releasing switch

(76) Inventor: Eric Yeatman, London (GB)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/510,511

(22) PCT Filed: Apr. 4, 2003
(86) PCT No.: PCT/GB03/01470

(30) Foreign Application Priority Data
Apr. 9, 2002 (GB) 0208175.0

(51) Int. Cl. H01H 51/22

(52) U.S. Cl. 335/78

(57) ABSTRACT

A MEMS (microelectromechanical system) electrical switch device is provided for circuit protection applications. The device includes a mechanical latching mechanism by which the switch is held in the closed position, and a mechanism by which this latch is released when the load current passing through the device reaches or exceeds some desired magnitude. In addition, a mechanism is provided by which the switch may be reset to its closed position by applying an electrical control voltage to certain terminals of the device. A number of these devices, or arrays of these devices, can be fabricated by parallel processes on a single substrate, and photolithography can be employed to define the mechanical structures described above. Other embodiments include additional electrical isolation of the resetting mechanism, enhancement of the separation distance of the contact points of the switch in the open position, and prevention of arcing at the latch mechanism. A method of fabricating the device is provided. A method of using the aforementioned device is also provided.

### FIELD OF THE INVENTION

The invention relates to switches and in particular to micro-engineered switches. More particularly the invention relates to types of switches that may self-release thereby enabling a circuit breaking functionality to be incorporated within the switch.

### BACKGROUND OF THE INVENTION

Electrical circuits are frequently connected to a source of power in such a way that the connection is broken if the current drawn from the power supply exceeds some previously determined level. The excessive current demand will often be due to a failure in the system, such as a short circuit being formed by the failure of a component. Isolating the circuit in such a case may prevent or limit damage to the circuit itself, the power supply, or associated systems, and reduce the risk of fire or electrical shock. Isolation may be achieved by a fusible link or “fuse”, or by a reusable switch, generally known in this context as a circuit breaker. The fuse will generally be of lower cost, but must be physically replaced in the event of an isolation incident occurring. The circuit breaker can be reset, usually through manual mechanical actuation, and thus a single device can provide protection for a number of incidents.

While solid state devices are the preferred option for many circuit isolation applications, for many others electromechanical switching is more suitable. Electromechanical switches (usually magnetically actuated relays), offer low insertion loss, high current handling for a given size due to reduced heat dissipation, a broader range of current vs. time response characteristics, ability to handle surges, and high open circuit isolation. An example is U.S. Pat. No. 3,849,752. In this device a thermally sensitive longitudinally expandable plunger is enclosed in a conductor casing connected in series with the circuit breaker switch. In one embodiment the conductor casing has a suitable resistance for heating the plunger for tripping the circuit breaker at excessive current levels.

Conventional circuit breakers have also been described which are used to break a current path in the case of a general thermal overload condition, rather than at a designated current load. An example is provided by U.S. Pat. No. 6,154,116, which describes a thermal circuit breaker and switch. In that invention, a bimetallic element is employed to effect the tripping of the switch when an overload condition is reached. Resetting is done for both the aforementioned devices via a manually operated actuator.

Improved manufacturing techniques have allowed traditional relay designs to achieve much lower cost at higher reliability. Never-the-less, both the size and cost of circuit breakers currently manufactured are excessive for some applications, and the sophistication of their operation is limited. Thus there is a need for improved designs of circuit breakers, intended to handle modest current levels, that provide complex functionality, low cost and low overall size. One possibility for achieving such designs is to take advantage of the manufacturing techniques of the semiconductor industry, particularly parallel manufacturing of large numbers of components on single substrates, and the parallel definition of complex structures by photolithography. More specifically, the opportunity exists to use the manufacturing technology of micro-electro-mechanical systems, or “MEMS”. MEMS technology uses manufacturing techniques developed by, or similar to those used in, the semiconductor micro-electronics industry. This approach is naturally suited to sub-miniature relays, offering high functional complexity at low manufacturing cost, and improved integration of electromechanical functions with solid-state electronics.

Electrical MEMS relays and switches are known in the art. For example, patent No. WO9950863 describes a micromachined relay including a springing beam on which a magnetic actuation plate is formed. By the presence or absence of a magnetic field, the springing beam is bent so as to open or close a pair of electrical contacts, so creating an electrical short circuit or open circuit. With this or other similar devices, it would be possible to implement circuit protection using external current sensing and circuitry to obtain a trip signal by which the micromachined relay could be opened. However, protection should not be dependent on the proper working of external circuits, and thus the trip action should be intrinsic to the relay mechanism. Also, a separate current sensing mechanism would be required which did not itself have some undesired effect on the power supply, the load or the system as a whole.

U.S. Pat. No. 5,463,233 describes a micromachined thermal switch. In this invention a bimetallic plate is provided which bends according to its temperature, such as to make electrical contact between a pair of terminals for a certain temperature range. In that invention, additional electrostatic actuation forces are provided so as to give the switch a snap action and thus reduce arcing when the gap between the fixed and moving parts of the electrical path is small. Here the temperature of the bimetallic plate is not controlled via the switched current.

In U.S. Pat. No. 6,211,598, a MEMS thermal actuator is provided, which gives in-plane mechanical motion by the use of a composite member having different degrees of thermal expansion. In that invention the heating of the composite beam may be effected by a mechanism intrinsic to the device. In that invention no means is provided by which the actuator may be employed to break the electrical path of the current by which the actuating heat is provided.

In Xi-Qing Sun, K. R. Farmer, W. N. Carr, Proc. IEEE MEMS Workshop, 1998, a bi-stable MEMS relay is reported in which a cantilever is held in the closed position by a mechanical catch mechanism. Closing and opening of the relay switch is effected by applying voltages in the correct -sequence to each of two thermal actuation structures comprising the cantilever, such that the cantilever deforms so as to achieve both the closing or opening and the latching or unlatching. The intended application is given as switching of high frequency signals, and no provision is made for opening of the switch in response to the switched load current.

A laterally moving thermal MEMS actuator is described in Comtois & Bright, Sensors & Actuators A58(1), 1997, using two element cantilevers in which one element heats preferentially when a current is passed through the device. The applications described are for motors and optical structures.

Micromachined MEMS devices have been described which use electrostatic forces to operate electrical switches and relays. Typically in these devices, cantilever beams separated from the underlying substrate have electrical contacts at their free ends, such that these contacts move as the cantilever deflects, so that electrical connections may be made or broken to additional contacts fixed on the substrate. For example, U.S. Pat. Nos. 5,367,136, 5,258,591, and 5,268,696 to Buck et al., U.S. Pat. No. 5,544,001 to Ichiya, et al., and U.S. Pat. No. 5,278,368 to Kasano, et al. are representative of this class of MEMS switch and relay devices. More specifically, U.S. Pat. No. 6,229,683 describes a high voltage micromachined switch. In that invention, a composite beam is deflected by electrostatic forces, and in this way electrical connection is made or broken between electrical contacts fixed on a substrate. In addition, features are incorporated including the use of multiple contacts, and electrically isolated contacts, so as to reduce the possibility of arc formation when high voltages are applied to the device in its open state. The control of the device, however, remains functionally separate from the electrical path which is switched, and thus an intrinsic circuit protection function is not provided.

A further example of a cantilevered switch device is described in International application WO 02/17339. This specification describes MEMS switches using pairs of cantilevered, thermally driven actuators. The control of this device is functionally separate from the electrical path which is switched. Furthermore, the construction of the switch is such that a sequence of steps requiring an actuation of both cantilevers is required to effect an adoption of one of the two states of the switch.

These and other problems associated with the prior art means that there is a need for an electromechanical switch that can be re-settable in an efficient manner.

It is therefore an object of the present invention to provide a re-settable electromechanical circuit breaker switch, suitable for fabrication by MEMS technology.

### SUMMARY OF THE INVENTION

Accordingly, the present invention provides a micro-electromechanical switch comprising:
a substrate;
first and second conductive cantilevers on the substrate;
the second conductive cantilever being flexible with respect to the first from a rest position at which the two are mechanically and electrically isolated to a latched position at which they are mechanically latched to form an electrical connection, the latched position being effected on application of a control current through the second cantilever;
the first conductive cantilever being flexible with respect to the second from a corresponding latched position to a release position at which the two are no longer mechanically latched; and
a first current path passing through the said electrical connection such that the passage of a first threshold electrical current through the first current path causes the first cantilever to flex from its latched position to its release position, thus breaking the said electrical connection and allowing the second conductive cantilever to return to its rest position.

It will be appreciated that the electrical connection formed through the latching of the first and second cantilevers may or may not be a connection between the individual cantilevers but could be a connection through one of the cantilevers and a third component.

Preferably, the switch further comprises a second current path associated with the second cantilever such that the passage of a second threshold electrical current through the second current path causes the second cantilever to flex from its rest position to its latched position. This enables the switch to be reset by the application of an electrical current.

The switch is preferably fabricated by fabricating a base for attachment of the cantilevers on a first level, fabricating moving parts of the cantilevers on a second level and fabricating electrical contacts of the cantilevers on the second level or a third level, wherein each level is formed by the deposition and patterning of a sacrificial layer that is used as a mould for the fabrication of the conductive parts.

In another embodiment, the invention provides an microelectromechanical switch comprising:
a substrate;
a first cantilever attached to, but electrically isolated from, the substrate, having two longitudinal segments, the first of which is electrically connected at the fixed end to a first primary electrical terminal and the other of which is electrically connected at the fixed end to an additional terminal, and the two members being attached to each other at a point along their lengths;
a second cantilever attached to, but electrically isolated from, the substrate, having two isolated longitudinal segments, each of which is electrically connected at the fixed end to a secondary terminal, and the two members being attached to each other at a point along their lengths, and the cantilever having an electrical contact point at its distal end;
a fixed electrical contact point attached to, but electrically isolated from, the substrate, and electrically connected to a second primary electrical terminal; and
wherein the two cantilevers are not in mechanical contact when in their relaxed state.

Desirably each of the two cantilevers have attached mechanical parts which cause them to be mechanically linked together when one is deformed such as to bring it in contact with the other, and this linkage is such that the cantilevers remain in contact when the actuation force which effected this contact is removed.

When the two cantilevers are in contact, the two contact points (that on the second cantilever and that on the fixed part) are typically held in contact, and consequently a low resistance electrical path is obtained between the first and second primary terminals.

Desirably, the passing of an electrical current between the primary terminals, when the two cantilevers are latched together, causes heating of the first longitudinal segment of the first cantilever in such a way as to induce its deformation, and wherein this deformation is sufficient, on the passing of certain such currents for sufficient time, to cause the latching mechanism to be released, and the two cantilevers to separate, and so causing interruption of the low resistance path between the primary terminals.

Typically, the actuation of the second cantilever to bring it into contact with, and cause it to be latched to, the first cantilever, can be effected by the passing of a current between the two secondary terminals, by the effect of differential thermal expansion associated with heating of the cantilever by the passed current.

An additional electrical path may be provided between the primary terminals through the second longitudinal element of the first cantilever, and wherein the relative amount of current flowing through the two electrical paths may be determined by the connection of a resistor between the two terminals of the first cantilever, and wherein the total current required to release the latch mechanism may so be altered.

The second cantilever desirably includes an additional mechanical structure such that the relative motion of the electrical contact point between the latched and relaxed states of the cantilever is substantially greater than the relative motion of the moving end of the cantilever at the point at which this mechanism is attached.

An additional actuator may be provided which is electrically isolated from the two cantilevers, and wherein this actuator may be used to bring the two cantilevers into contact and to cause them to be latched together, by the mechanical contact of this actuator against one of the cantilevers. The additional actuator is desirably in the form of a third cantilever, having two isolated longitudinal segments, each of which is electrically connected to a terminal, and wherein the passing of a current between the terminals of this third cantilever causes the movement of the actuator as required.

According to a further embodiment of the invention a method of fabrication of an electromechanical switches is also provided in which base parts for the cantilevers are fabricated on one level, the cantilevers on a further level, and the contact points on a further level, each level being formed by the deposition and patterning of a sacrificial polymer layer, for example photoresist, and this layer being used as a mold for the electroplating of the parts in metal, the polymer layers being subsequently removed.

According to a further embodiment a device consisting of a package containing a single die cut from a substrate on which electromechanical switches have been fabricated is provided, wherein more than one such switch is included on the die, and is thus accessible from the terminals of the package.

The invention may also provide an application wherein a electromechanical switch or array of switches connected between one or more circuits requiring protection and one or more voltage sources is provided, such that the connection between any of the circuits requiring protection and any voltage source is disconnected if the current between them exceeds a certain level for a certain duration of time. Such an application may also include a control circuit which monitors the state of the protected terminals, and possibly also monitors aspects of the state of the protected circuits, and according to the its programming applies voltages to the switch or switches at the appropriate terminals so as to reset the corresponding switch and thus reestablish electrical connection of the relevant protected circuit and voltage source.

The substrate of the switching device may includes an electronic circuit which is electrically connected to the switching device and wherein this electronic circuit provides or contributes to some control function of the switch or some related function.

### BRIEF DESCRIPTION OF THE DRAWINGS

The present invention will now be described by way of example with reference to the accompanying drawings, in which:

FIG. 1A is a plan view of a preferred embodiment of the invention in the open state, showing the two cantilevered structures, the latch mechanism, the electrical terminals and the electrical contact points of the switch.

FIG. 1B shows the same mechanism in the closed state, with one cantilevered structure in a non-relaxed state held in contact with the other by the latch mechanism.

FIG. 2 shows an external electrical connection used to prevent arcing at the latch mechanism, by keeping both sides of the latch at the same potential.

FIG. 3 shows the use of an external resistor to increase the trip current.

FIG. 4A and 4B show the invention in open and closed state, respectively, with the addition of a feature to magnify the displacement of the moving contact point, to increase the degree of isolation in the open state.

FIG. 5 shows a variation of the invention in which the resetting mechanism is electrically separate from the path of the primary current.

FIG. 6 illustrates a preferred fabrication technique for the invention.

FIG. 7 illustrates an array of devices suitable for packaging as a single device.

FIG. 8 illustrates a potential use of the device in the protection of an electronic system; and

FIG. 9 shows a variation of the invention in which the electrical connection is made by bringing one contact against both parts of a split contact.

### DETAILED DESCRIPTION

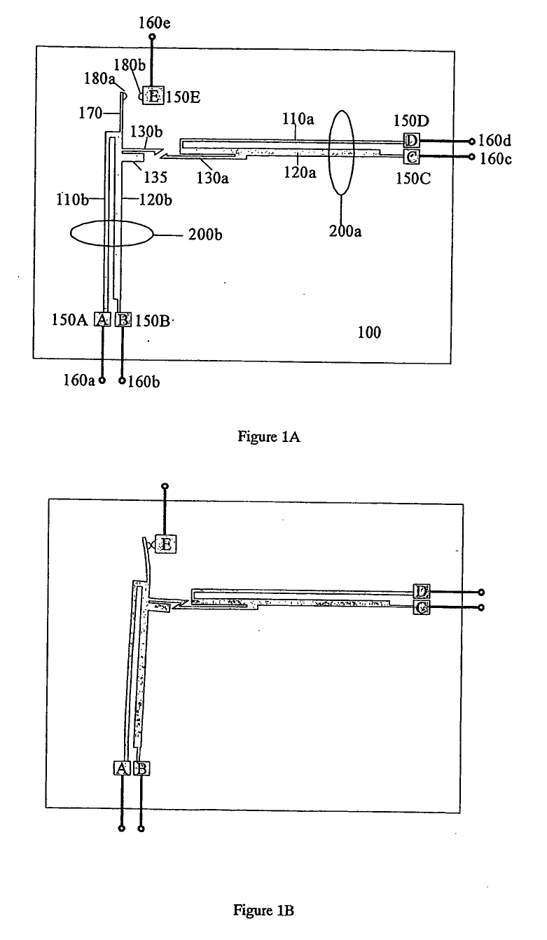

Referring in detail to the drawings where similar parts are identified by like reference numbers, there is seen in FIGS. 1A and 1B a diagram of a circuit breaking switch in its open and closed position respectively. The switch is mounted in such a way as to present a number of electrical terminals 160 for connection to a printed circuit board or otherwise for connection to external electrical circuits. These terminals could be for example the pins of a standard semiconductor package of a type used conventionally for mounting of integrated circuits on printed circuit boards. Terminals 160d and 160e provide the power supply and load connection respectively, such that the purpose of the switch is to prevent excess current levels from flowing from the supply to the load. Each external terminal 160 is electrically connected, for example by wire bonding, to a fixed anchor 150, each anchor being a part mechanically fixed to, but electrically isolated from, the substrate. The substrate may be a silicon wafer, or some other planar substrate suitable for processing with semiconductor process equipment such as photolithography tools.

A first cantilever 200a has two parallel members, 110a and 120a, which are mechanically and electrically connected to anchors 150D and 150C respectively at their proximal ends. The parallel members 110a and 120a are connected to each other mechanically and electrically at some distal point, which may be the distal end of one or both of them, although one or both may extend beyond this connection point. The cantilever includes or comprises an electrically conductive layer such that a low resistance electrical path is provided, running sequentially through members 110a and 120a, from anchor 150D to 150C.

A second cantilever 200b includes two parallel members 110b and 120b, which are connected to, and provide an electrical path between, anchors 150A and 150B in the manner of the equivalent members of the first cantilever. Anchors 150A and 150B are connected to external terminals 160a and 160b respectively, in the manner of the connection of anchors 150a and 150b to their corresponding terminals. The second cantilever includes a flexible member 170 connected at its distal end which provides a low resistance electrical path from the connection point of members 110b and 120b to an electrical contact, 180a. A second electrical contact 180b is attached to a further anchor 150E which is itself connected to a terminal 160e in the manner previously described.

Both cantilevers 200a and 200b have attached latch parts, 130a and 130b respectively. In the open position of the switch, as illustrated in FIG. 1A, there is no electrical or mechanical connection between the cantilevers 200a and 200b, and no electrical or mechanical connection between the contacts 180a and 180b. The two cantilevers 200a and 200b, including the members 110, the latch parts 130 and the part 170, are fabricated such that they are not in mechanical contact with the substrate underneath them, and are only mechanically connected to the anchors 150, and thus indirectly to the substrate.

A current may be passed through cantilever 200b by the application of a suitable voltage between terminals 160a and 160b. As a result of the electrical resistance of members 110b and 120b, such a current causes heating of these members. This heating causes the members to increase in length. The members are fabricated in such a way that the increase in length experienced by member 110b is greater than that experienced by 120b. This may be achieved by member 110b being narrower than 120b, so that its resistance is greater. The difference in length increase will cause the cantilever 200b to bend, such that the two contacts 180a and 180b come into contact with each other, and the catch mechanisms contact each other. With application of the correct current for sufficient time, the cantilever 200b will bend past the point where the contacts 180a and 180b meet, such that member 170 bends, and the catch parts 130a and 130b engage with each other.

Upon engagement of the catch parts, the cantilevers 200a and 200b remain mechanically locked together even after the current between terminals 160a and 160b ceases, such that the contacts also remain held together by a force resulting from the bending of member 170. A low resistance electrical path is now provided between the primary terminals 160d and 160e. This path passes through member 110a, through the catch parts 130a and 130b, through member 170 and through the contacts 180a and 180b. Current flowing through this path (the “load” current) causes heating of member 110a, which consequently expands in length and causes cantilever 200a to bend. This bending causes the catch parts 130a and 130b to begin to separate, such that when the desired trip current is reached for sufficient time, the catch releases, and cantilever 200b returns to its relaxed position. As a consequence of this movement, the electrical path between the primary terminals is broken.

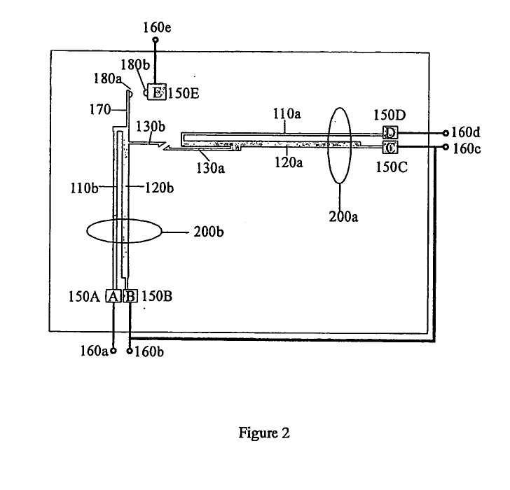

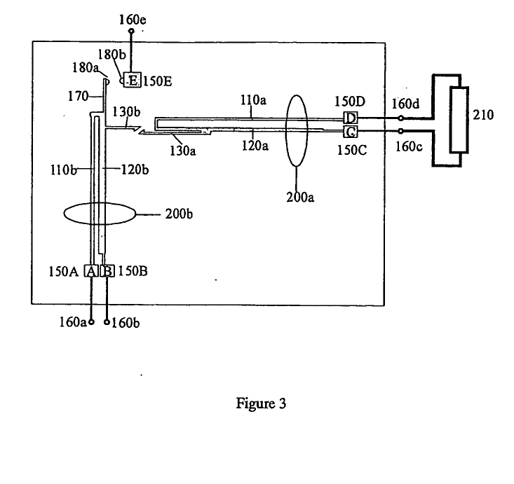

With reference to FIG. 2, it may be desirable to prevent the formation of an electrical arc between the catch parts during the setting of the switch. This avoids the fabrication of catch parts that can withstand such arcing. This can be achieved as illustrated, by providing an electrical connection between terminals 160c and 160b. This connection may be within the device as packaged, or provided by external circuitry. With such a connection effected, the two catch parts are kept at the same voltage, and an additional current path between the primary terminals is provided, passing consecutively through members 110a, 120a, 120b and thence member 170 and the contacts as before. With reference now to FIG. 3, it may also be desirable for the user to vary the load current at which the switch trips (the ‘trip current’s). A convenient possibility for the user is to connect a resistor between terminals of the device, and this resistor should be, for convenience, of a higher resistance than that of the low resistance path through the switch in its closed state. Such a possibility is obtained through the correct design of cantilever 200a. A resistor 210 is connected between terminals 160d and 160e. This allows part of the load current to travel sequentially through this resistor and through member 120a, in parallel to the path through member 110a. This reduces the difference in lengthening between members 110a and 120a as the load current increases, and thus increases the total load current required to trip the switch. By varying the relative dimensions of members 110a and 120a, the range of trip current values and the corresponding resistance values for resistor 210 can be varied.

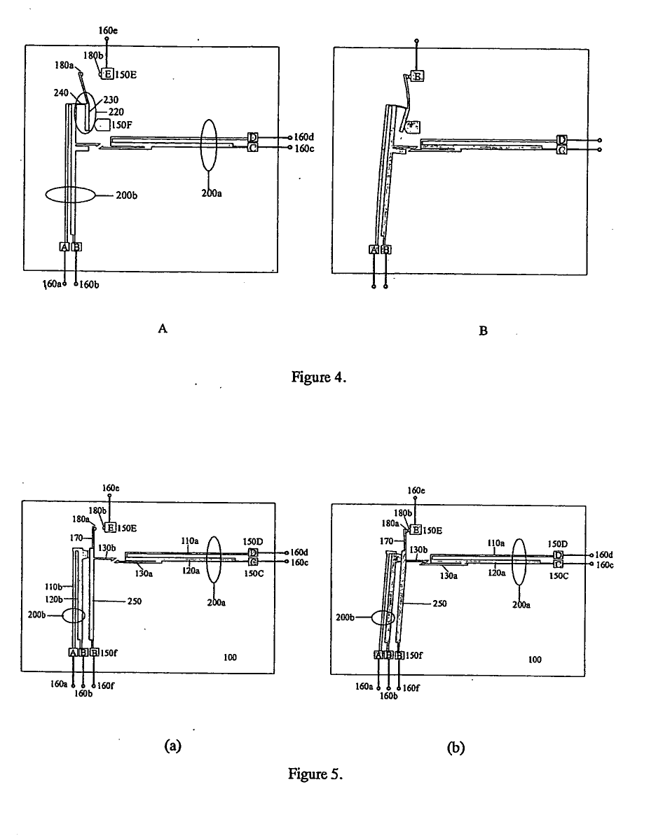

Referring now to FIG. 4, it may be desirable to increase the separation of the contacts 180a and 180b in the open state of the switch, to increase the voltage necessary to cause an arc to form between them, and it may also be desirable to increase the speed at which these contacts separate at the moment of tripping. This can be provided by the addition of a part 220 to cantilever 200b. This part makes mechanical contact with an additional fixed anchor 150F when the switch is closed, in such a way that member 230 of this part 220 rotates by the bending of an additional member 240. By this construction the total displacement of the moving contact 180a, and therefore its velocity during tripping and its maximum separation from contact 180b, are increased.

Referring now to FIG. 5, it may be advantageous to increase the security of the circuit breaking function, to reduce the possibility that the load connected to terminal 160e may obtain power from the external circuitry connected to terminal 160b, for example as a result of failure in that circuitry. Such a current path would reduce the current through member 110a, and therefore increase the trip current. This increased security is achieved by the addition of a third cantilever 250, which includes the catch part 130b and the member 170 and the attached contact 180a, but does not require the two parallel member structure. It is connected to a single anchor and terminal, 150f and 160f respectively. The resetting cantilever now no longer requires the parts 130a, 170 and 180a. Resetting of the switch is performed by passing a current between terminals 160a and 160b as described previously. FIG. 5(b) shows this switch in the state of being reset. When this setting current ceases, cantilevers 200a and 200c remain in mechanical and electrical contact with each other, while cantilever 200b returns to its rest position. In this state there is no electrical path between the circuits connected to cantilever 200b and the primary terminals 160d and 160e.

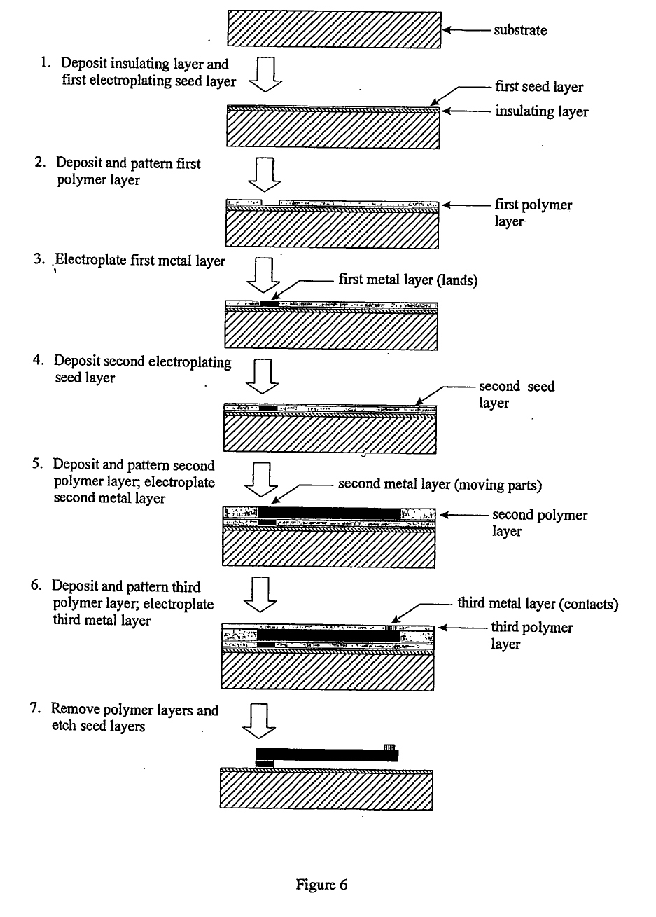

The cantilevers, anchors and contacts may be fabricated on a substrate using sacrificial layer processing, as is well known in the art. An example is given in FIG. 6, in which a possible approach to fabrication of one of the cantilevers 200 is shown by way of illustration. A semiconducting substrate such as silicon is coated with an insulating layer, such as silicon dioxide, of a thickness and quality able to withstand the maximum voltage from which the external load is to be protected without becoming conducting or damaged. A thin metal layer such as copper is applied, for example by physical vapour deposition, to the surface of the insulating layer to act as a seed layer for subsequent electroplating. A first layer of polymer is applied, and patterned by photolithography to provide base layers for the anchors 150. The polymer may be photoresist which is directly patterned by photolithography. It may also be another polymer, such as polyimide, onto which a layer of photoresist is applied, this photoresist subsequently being patterned by photolithography and then used as a masking layer for patterning, for example by reactive ion etching, of the first polymer layer, after which the photoresist layer is removed, for example by dissolution in a solvent. The first polymer layer, having been patterned, is subsequently used as a mold for electroplating of the base using a suitable metal, for example copper.

The process of seed layer deposition, polymer patterning and electroplating is repeated in a further layer, at which level the main parts of the cantilevers 200, catch parts and other parts are fabricated. This layer will also be of a suitable metal, for example copper. The electrical contacts 180a and 180b may be fabricated on a third layer by a similar set of process steps, so as to be attached to the associated parts 170 and 150E respectively with some overlap in the desired area of contact. This layer may be fabricated by two sequences of polymer mold patterning and electroplating, so that the contacts may be of two different compositions, for example two gold alloys, in order to reduce the likelihood of the contacts fusing together during operation. All polymer layers are removed, leaving only the metal parts attached to the insulating layer on the substrate. The processes described above would be carried out on a whole wafer on which a number of devices would be fabricated in parallel. The wafer would then be diced into a number of individual components, which would then be packaged using packaging techniques and formats as known in the art for packaging of integrated circuits and other electrical and electronic components, particularly for mounting on circuit boards. Mounting of the individual dies could also be onto multi-chip modules, by bump bonding or other suitable techniques known in the art.

An alternative embodiment is also possible in which the mechanical parts are defined in a layer of silicon, for example a single crystal silicon layer bonded to a silicon wafer with an intervening oxide layer, a structure known in the art as bonded silicon on insulator (BSOI). The oxide layer would then provide the functions of an anchor, electrical isolation of the switch parts from the substrate, and a sacrificial layer for release of the moving parts from the substrate. A process of this type for forming MEMS devices from BSOI is described in Syms R. R. A., et al, Sensors and Actuators, vol. 88/3, pp. 273-283. The silicon layer could be heavily doped to provide high conductance, or additional metal layers could be deposited to provide a low resistance current path. Additional metal layers could also be deposited to form the contacts 180.

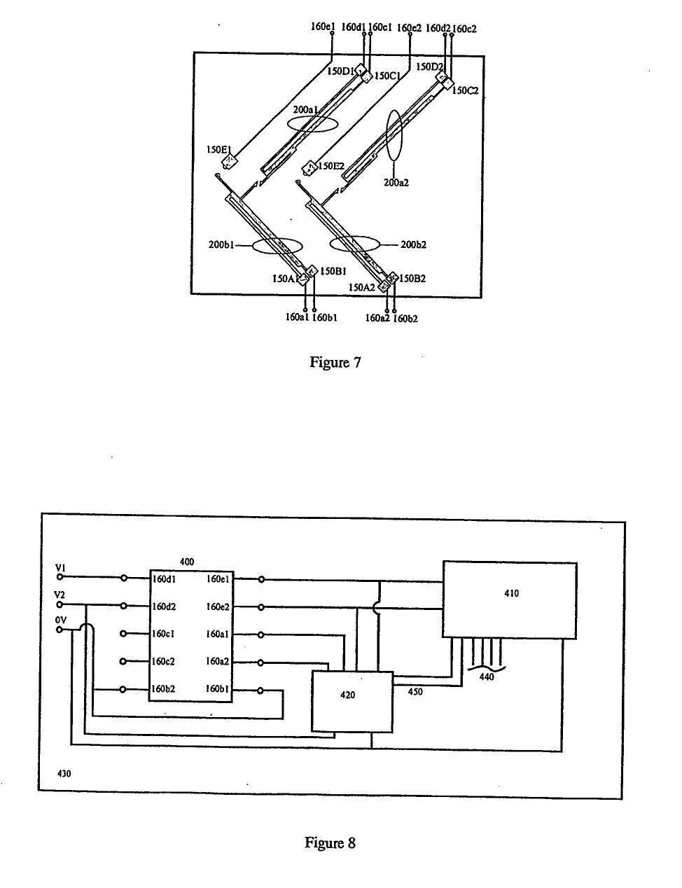

The device of the present invention is also suitable for fabrication in array form. In this case each die would include more than one switch, and would be packaged as a single package. FIG. 7 illustrates a die with two switches; the extension of this layout to larger numbers of switches will be obvious to one skilled in the art by inspection of this figure. This package would in general have separate terminals for each such switch, as indicated in the figure, where 160al indicates terminal 160a for the first switch, and so on. Some sharing of terminals, in order to reduce the package size, is also possible. For example, if connection between terminals 160b terminals 160c as in FIG. 2 are not to be employed, the anchor points 150b from all the switches could be connected to a single terminal 160b.

FIG. 8 illustrates an application of the present invention. A packaged device 400 containing 2 switches,.with terminals for each switch labelled as in FIG. 7, is mounted on a printed circuit board 430. Power to the circuit board is provided at two voltages with respect to earth (eg. +12V and −12V), at terminals labelled V1 and V2, with the earth terminal labelled 0V, although the extension of this application example to a single voltage or to larger numbers of supply voltages will be obvious by reference to this figure to one skilled in the art. An application circuit represented by block 410 requires power from the supply voltages, but also needs protection from excessive currents. This is provided by connecting 410 to the supply terminals via the circuit protection device 400. An additional control circuit 420, which may be a single digital integrated circuit, is also mounted on the circuit board 430. This control circuit is directly powered from one or more of the supply terminals, and monitors terminals 160e1 and 160e2 to sense whether a trip event has occurred. It also may monitor one or more terminals 450 on the application circuit 410 to sense desired aspects of the state of this circuit.

According to the state of the sensed lines, and according to the logic in its design or programming, control circuit 420 will apply voltages to reset lines 160a1 and 160a2 as appropriate to reset the switches. The application circuit may also have additional connections 440 to other circuits, components or terminals on or off the circuit board. In addition, the switch parts could be fabricated on a substrate having electronic circuitry on it, and this circuitry could include all or part of the control circuit function, thus providing a monolithic device with both the electromechanical and the control circuit functions on a single chip.

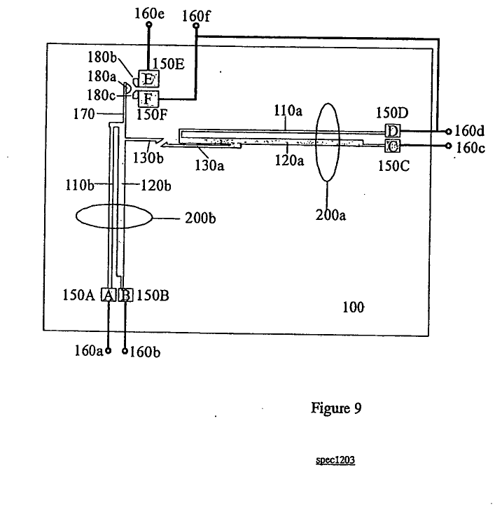

With reference to FIG. 9, it may be desirable to avoid the need for the protected current to flow through member 170, as this member may be of excessive electrical resistance. This can be achieved as illustrated, by replacing the single fixed contact 180b with a split contact having two parts 180b and 180c. These parts 180b and 180c are attached, respectively, to anchors 150E and 150F, which are in turn connected, respectively, to terminals 160e and 160f in the manner previously described.

In this embodiment, in the state in which the first and second cantilevers are latched together, the moving contact 180a makes electrical contact with both parts 180b and 180c of the split contact. As illustrated, an electrical connection can also be provided between terminals 160d and 160f. This connection may be within the device as packaged, or provided by external circuitry. With such a connection effected, terminals 160c and 160e act as the primary terminals of the device, and the load current passes sequentially through the first cantilever and through the two contact parts 180b and 180c via contact 180a.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limiting the scope of the present invention in any way.

It will be appreciated that the present invention provides a switch that opens, or “trips”, when the load current exceeds a desired value for more than a desired time, as a result of a mechanism intrinsic to the switch device of the present invention. It will be further understood that the switch device of the present invention may be closed, or “reset”, by the application of an electrical current. These and other features of the present invention have been described with reference to preferred micromechanical devices that include a substrate onto which are attached conductive parts which, when in contact with each other, provide a low resistance path between two primary terminals. These parts include two or more cantilevered structures which are mechanically fixed to the substrate at one end, but are free to move at the other end when deformed, in a motion primarily parallel to the surface of the substrate. When they are in their relaxed state, these structures are not in electrical contact with each other, and a high resistance obtains between the primary terminals. Deformation is caused by differential thermal expansion, where as a result of a difference in temperature change or thermal expansion coefficient between different parts of a structure, heating causes the structure to bend. The low resistance contact is made by one of the structures being deformed in this way, such that the two structures previously not in electrical contact come into contact, and the two structures are held in contact by a latching mechanism. Passing of a current (the “Load current”) between the primary terminals is possible when (and only when) the two structures are in contact, and the device is constructed such that the load current must pass through one of the cantilevered structures in such a way that deformation by differential thermal expansion is caused as a result of heating due to ohmic resistance. The structures are configured such that when this deformation exceeds an amount corresponding to the desired trip current, the latch is released and the cantilevered structures separate, breaking the low resistance path between the primary terminals.

Resetting of the device of the present invention is desirably effected by the application of a current between two resetting terminals, one of which may be common to one of the primary terminals. This current causes deformation of one of the cantilevered structures by the method previously described, in such a way as to bring the two cantilevered structures into contact, and to latch them together. This resetting function may be provided by a current in one of the load current carrying structures, or it may be applied to an additional structure which is electrically isolated from the load current carrying structures, but which moves one of these by mechanical contact in order to achieve the resetting function. This additional structure provides additional protection, by ensuring that the behaviour (including the failure) of any circuitry connected to the resetting terminals does not provide an alternative current path for the load, or otherwise alter the electrical behaviour of the load current carrying portion of the present invention. As such, it will be appreciated that the present invention is not intended to be limited in any way except as may be deemed necessary in the light of the appended claims.

References

| | |
|---|---|
| U.S. Pat. No. 3849752- | Bayer; Eric W., |
| U.S. Pat. No. 5258591- | Buck; Daniel C., |
| U.S. Pat. No. 5268696- | Buck; Daniel C., |
| | Grice; Steven, |
| U.S. Pat. No. 5278368- | Kasano; Fumihiro, Nishimura; Hiromi, et al |
| U.S. Pat. No. 5367136-- | Buck; Daniel C., |
| U.S. Pat. No. 5463233- | Norling; Brian L., |
| U.S. Pat. No. 5544001- | Ichiya; Mitsuo et al |
| U.S. Pat. No. 6154116- | Sorenson; Richard W., |
| U.S. Pat. No. 6211598- | Dhuler; Vijayakumar R., et al |
| U.S. Pat. No. 6229683- | Goodwin-Johansson; Scott Halden |
| WO9950863- | Tai, Yu-Chong, Wright, John, A. |
| WO 02/17339 | JDS Uniphase Corp. |

Xi-Qing Sun, K. R. Farner, W. N. Carr, Proc. IEEE MEMS Workshop, 1998, 154-159 Syms R. R. A., Gomley C., Blackstone S. “Improving yield, accuracy and complexity in surface tension self-assembled MOEMS” Sensors and Actuators, 88/3,273-283 (2001) Comtois J H, Bright V M, “Applications for surface-micromachined polysilicon thermal actuators and arrays”, Sensors & Actuators A58(1), 1997, pp. 19-25

1. A micro-electromechanical switch comprising:
a substrate;
first and second conductive cantilevers on the substrate;
the second conductive cantilever being flexible with respect to the first from a rest position at which the two are mechanically and electrically isolated to a latched position at which they are mechanically latched to form an electrical connection, the latched position being effected on application of a control current through the second cantilever;
the first conductive cantilever being flexible with respect to the second from a corresponding latched position to a release position at which the two are no longer mechanically latched; and
a first current path passing through the said electrical connection such that the passage of a first threshold electrical current through the first current path causes the first cantilever to flex from its latched position to its release position, thus breaking the said electrical connection and allowing the second conductive cantilever to return to its rest position.

2. A micro-electromechanical switch according to claim 1 to which:
the first cantilever comprises two elongate conductive members mechanically attached to one another at a point along their lengths; and
the first current path passes through at least one of the elongate conductive members of the first cantilever, such that the passage of the first threshold electrical current through the first current path causes differential thermal expansion of the elongate conductive members, thus causing the first cantilever to flex.

3. A micro-electromechanical switch according to claim 2 in which:
the elongate conductive members are of substantially the same electrical resistivity and thermal expansivity;
the first current path passes through both of the elongate conductive members of the first cantilever; and
passage of the first threshold electrical current through the first current path gives rise to different current densities in the two elongate conductive members, thus causing differential thermal expansion.

4. A micro-electromechanical switch according to claim 3 in which the first current path passes through the elongate conductive members of the first cantilever in parallel and further comprising a resistor coupled into one of the parallel current paths thus created to determine the value of the first threshold electrical current.

5. A micro-electromechanical switch according to claim 1 in which the first current path passes through the second cantilever to an electrical contact thereon and thence to a fixed electrical contact on the substrate.

6. A micro-electromechanical switch according to claim 5 in which the electrical contact on the second cantilever and the fixed electrical contact on the substrate are mechanically and electrically isolated when the second cantilever is in its rest position and are in mechanical and electrical contact when the second cantilever is in its latched position.

7. A micro-electromechanical switch according to claim 5 in which the second cantilever includes a lever arrangement that exaggerates the movement of the electrical contact on the second cantilever as the second cantilever is flexed from its rest position to its latch position.

8. A micro-electromechanical switch according to claim 1 in which the first cantilever is a unitary component.

9. A micro-electromechanical switch according to claim 1 further comprising;
a second current path associated with the second cantilever such that the passage of a second threshold electrical current through the second current path causes the second cantilever to flex from its rest position to its latched position.

10. A micro-electromechanical switch according to claim 9 in which:
the second cantilever comprises two elongate conductive members mechanically attached to one another at a point along their lengths; and
the second current path passes through at least one of the elongate conductive members of the second cantilever, such that the passage of the second threshold electrical current through the second current path causes differential thermal expansion of the elongate conductive members, thus causing the second cantilever to flex.

11. A micro-electromechanical switch according to claim 10 in which:
the elongate conductive members of the second cantilever are of substantially the same electrical resistivity and thermal expansivity;
the second current path passes through both of the elongate conductive members of the second cantilever; and
passage of the second threshold electrical current through the second current path gives rise to different current densities in the elongate conductive members, thus causing differential thermal expansion.

12. A micro-electromechanical switch according to claim 9 in which the second cantilever is a unitary component.

13. A micro-electromechanical switch according to claim 9 in which the second cantilever is a two-part component comprising: a first component through which the first current path passes: and a second component through which the second current path passes.

14. A micro-electromechanical switch according to claim 1 in which the two cantilevers include respective resilient deformable latching projections that resiliently latch one another as the second cantilever flexes from its rest position to its latched position and disengage from each other as the first conductive cantilever flexes from its latched position to its release position.

15. A micro-electromechanical switch according to claim 1 comprising a plurality of such first cantilevers and a corresponding plurality of such second cantilevers, forming a plurality of independent switches on a common substrate.

16. A micro-electromechanical switch according to claim 15 in the form of a package containing a single die and wherein the electrical current paths for each switch are accessible from the terminals of the package.

17. A micro-electromechanical switch according to claim 1 further comprising a split contact, the split contact having two legs, a first leg being coupled to the first cantilever thereby providing a current path from the first cantilever to the split contact and wherein on adoption of the latched position by the second cantilever, a current path is provided between the first and second legs of the split contact, thereby electrically coupling the second leg to the first cantilever.

18. A micro-electromechanical switch according to claim 17 wherein the current path between the first and second legs is provided via a contact provided on an end portion of the second cantilever.

19. (canceled)

20. A device comprising:
a power source;
one or more circuits requiring protection;
a micro-electromechanical switch according to claim 9 connected between the power source and the one or more circuits requiring protection; and,
a control circuit adapted to pass the second threshold electrical current through a selected second current path to establish an electrical connection between a corresponding circuit requiring protection and the power source in accordance with predetermined conditions.

21. A device comprising a micro-electromechanical switch according to claim 1 and an electronic circuit provided on the substrate and connected to the switch.

22. (canceled)

23. A method of fabricating a micro-electromechanical switch according to claim 1 comprising:
fabricating a base for attachment of the cantilevers on a first or level;
fabricating moving parts of the cantilevers on a second level; and,
fabricating electrical contacts of the cantilevers on the second level or a third level, wherein each level is formed by the deposition and patterning of a sacrificial layer that is used as a mould for the fabrication of the conduct parts.

24. A method according to claim 23 in which the sacrificial layer is a polymeric photoresist.

25. A method according to claim 23 or claim 24 in which the conductive parts are metallic parts formed by electroplating.

26. (canceled)
